(19) United States
(12) Patent Application Publication
(10) Pub. No.: US 2005/0021803 A1
(43) Pub. Date: Jan. 27, 2005

(54) Messaging of arbitrary-length video and audio content

(76) Inventor: Paul I. Wren III, Montecito, CA (US)

Correspondence Address: Paul I. Wren, III, 327 San Ysidro Road, Montecito, CA, 93108, US

(21) Appl. No.: 10/455,977

(22) Filed: Jun. 9, 2003

(51) Int. Cl. G06F 15/16

(52) U.S. Cl. 709/231

(57) ABSTRACT

The invention is a multimedia video messaging system that provides an end-user with the ability to record and send arbitrary-length audio and video content. The system can encompass a variety of devices such as a mobile phone, cordless phone, and PC with an embedded or attached camera and digital signal processing capabilities to capture and encode an arbitrary length of video and audio into a format that can be streamed or attached to an electronic message. From an address-book listing or using the network identifiers for recipients in an active voice or video call, the end-user may press one button to initiate and send recorded video and audio without further input. When the video exceeds X kb where X is determined by the bandwidth of the end-to-end communication between the device and the messaging server (e.g. phone lines in the current worst case), the video and audio streams to a remote disk that is available on the world-wide web and a message is created and sent with a URI to the streamed media embedded in the body of the message. If the video is less than X kb, a message is created and sent with compressed video attached. When the message is received, an end-user can click on the attachment or the URI to play the video and audio.

### BACKGROUND

1. Field of Invention

The invention relates to a multimedia video messaging system. In particular, the invention relates to multimedia devices conditionally sending audiovisual messages that are automatically addressed to recipients based on one-touch activation and contain an attachment with the video and audio recording or embedded reference to a playable stream of the video and audio recording residing on the originating home network.

2. Description of Related Art

The exchange of movie messages that contain video and audio between devices such as a PC or mobile phone is a frequent and convenient means of communication. For example, in the case of a mobile phone, an end-user can point a mobile phone's camera, record a small movie and send the movie to another mobile user with a compatible device or via the Internet to an e-mail recipient. However, the size of the movie message is predetermined by the designers of the mobile phone based on the networking capabilities of the device. In current art of mobile data technology, the size of the movie message is constrained to less than 20 or 30 kilobytes as limited at the time of manufacturing.

In addition, sending a movie message as currently implemented with current art is a cumbersome process for an end-user. With current art, the end-user must first transfer video from a video camera to a PC using specialized wire connections or utilize short-range wireless networking devices to transfer the movie messages to a device that can then initiate a connection for send. Furthermore, the end-user experience may be further degraded if the size of the file transferred from the camera to the PC is significantly large and requires a substantial waiting period to not only send the file to the PC but also to the Internet.

Optimizing the end-user experience of sending video and audio messages is considered in U.S. Pat. Application 20020049852 but, in order to enable an end-user experience that will stimulate mass market adoption, several techniques are missing. First, the end-user should not have to enter further end-user input when the message is initiated at the time the recipients are known to the device. There are multiple scenarios where the recipients are known to the device at the time of send including from the address-book or during an active video or voice call. Second, one of the primary success factors for a mass-market experience is a near instant send of the message. This introduces the need to eliminate initialization or bandwidth testing at the time of send and the requirement to ready the method prior to being invoked by the end-user. Third, referencing movie messages with a URI is not always the ideal end-user experience. Ideally, the movie message is transferred at the time of send without a URI reference. This enables the end-user to view the message offline if the network is not available and minimizes interaction with the network. With the current art of Internet messaging systems, large message files such as 25 megabytes are commonplace and transported reliably although the experience latency for an end-user sending this message is still considerable on a broadband network and practically unfeasible for dialup speeds such as 50 kilobits per second. Although feasible, this is not practical for an end-user given the resources consumed by the device to transport the large message. For example, the end-user will not have access to other Internet services or the quality of the active voice call will degrade as the device attempts to multitask as larger message transport and high-quality voice call over a long period of time. In addition, a URI may be preferable over placing the message into an Outbox folder for transport while the user multi-tasks other functions of the device.

Accordingly, what is needed is a system and method for automatically addressing recipients so that further user input is not required at the time of send and sending the movie attached to the message or with an embedded URI that references the movie on the originating network depending on the quality metrics for the network connection available at the time of send. For example, the quality metric may dictate that messages greater than 50 KB should be sent with a URI and messages less than or equal to 50 KB should be sent as an attachment. This enables the end-user with a one-touch experience that optimizes the utilization of the network connection and minimizes latency in the end-user experience.

### SUMMARY

The primary object of the invention is to provide an end-user with a one-touch messaging capability to send movie messages containing video and audio of arbitrary length to recipients independent of the recipient's device capabilities over a network such as the Internet.

The method can be enabled with a variety of devices such as a mobile phone, cordless phone, and PC with an embedded or attached camera and digital signal processing capabilities to capture and encode an arbitrary length of video and audio into a format that can be streamed or attached to an electronic message. These devices would also include a memory for storing preferences, execution parameters, and movie messages and a display such as an LCD for presenting options and video to the end-user.

The end-user would initiate the method from a menu, address-book or an active voice or audio call screen. The menu would be a startup screen presented to the user with actions such as a command to initiate the method. The address-book would be a table of users and associated attributes such as an e-mail address and phone number maintained by the device. From an address-book entry, the end-user could initiate the method from a soft or hard button. The address-book module would then invoke the method and pass the e-mail address or phone number for addressing the message. The active screen would be the user presentation given an active video or audio call. From the active screen, the end-user could initiate the method from a soft or hard button. The active screen module would then invoke the method and pass the network identifiers of the active call participants for addressing the message.

Once invoked, the method provides a means to store the movie message of arbitrary length into virtual memory and send the message with either the movie attached to the message or referenced in the message with a URI that points to the originating network as a source for streaming. When the video exceeds X kb where X is determined by the bandwidth of the end-to-end communication between the device and the messaging server (e.g. phone lines in the current worst case), the video and audio streams to a remote disk that is available on the world-wide web and a message is created and sent with a URI to the streamed media embedded in the body of the message. If the video is less than X kb, a message is created and sent with compressed video attached. With conditional arbitrary length messages, the quality of the end-user experience is optimized to account for the amount of data recorded and the capabilities of the transmitting network at the time of the message send. When the message is received, an end-user can click on the attachment or the URI to play the video and audio.

After send, the end-user can optionally retain the movie message for repeatable access from another device such as a PC with a browser, file manager or a media access manager with a remote control. With the PC or media access manager, an end-user can replay sent movie messages or resend to other recipients.

### BRIEF DESCRIPTION OF THE DRAWINGS

The foregoing and other features and advantages of the present invention will be more clearly understood from the following detailed description and the accompanying drawings, in which,

FIG. 1 is an illustration of an end-user experience at the time of recording and sending a one-touch message. FIG. 1A is an illustration of an address-book end-user experience. FIG. 1B is an illustration of an end-user experience at the time of an active voice or video call.

FIG. 2 is a block diagram illustrating a mobile telephone with one-touch messaging of arbitrary length video and audio function according to an embodiment of the present invention.

FIG. 3 is a flow chart illustrating the high-level steps of the method for one-touch messaging of arbitrary length video and audio.

FIG. 4 is a flow chart illustrating the procedure for initializing the function at the start of recording a movie message of arbitrary length.

FIG. 5 is a flow chart illustrating the procedure for capturing and storing the movie message of arbitrary length containing video and audio.

FIG. 6 is a flow chart illustrating the procedure for sending the movie message of arbitrary length containing video and audio.

FIG. 7 is a flow chart illustrating the procedure to save the movie message to permanent storage.

FIG. 8 is a flow chart illustrating the procedure to compose and send the movie message.

FIG. 9 is an illustration of the end-user experience receiving the one-touch message with a compatible mobile phone or PC with a compatible e-mail client.

### DETAILED DESCRIPTION OF THE PREFERRED EMBODIMENTS

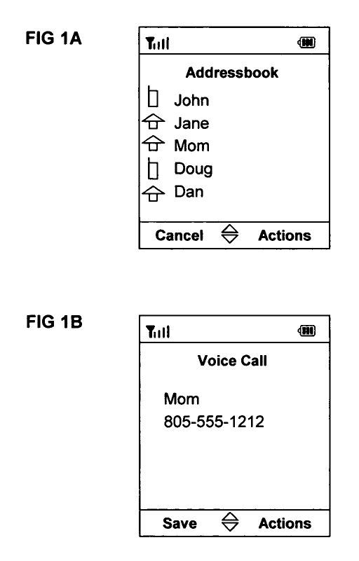

FIG. 1 is an illustration of an end-user experience to initiate a one-touch message of arbitrary length video and audio. FIG. 1A shows an example address-book view with a highlighted entry. In this illustration, a selection of entries is presented with an icon attribute that indicates if the phone number is to a home or mobile phone. An end-user can populate the address-book via add prompts pre and post voice and video calls or sync with an address-book residing on a network such as the Internet. The address-book view can result from a search or a top down presentation given a particular order such as alphabetical. From a highlighted entry, an end-user can record and send a movie message of arbitrary length. FIG. 1B shows an example user presentation during a voice call. During the voice call, an end-user can simultaneously record and send a movie message of arbitrary length without degrading or interrupting the voice or video call. From the active status page, the end-user could also save the entry to the electronic address-book.

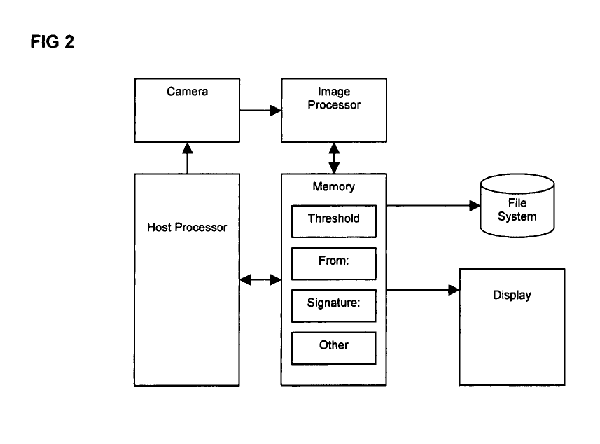

FIG. 2 illustrates a set of device components utilized to enable one-touch messaging of arbitrary length video and audio content including a host processor to control the overall operation of the method, GUI and display, a video camera, memory that stores user preferences and bootstrap parameters, a hard disk for a permanent storage file system, and an image process that compresses image data provided from the camera according to a standard moving picture compression technique such as MPEG. The components may be utilized to also present movie messages of arbitrary length received from compatible devices or compatible messaging systems that reside on the Internet.

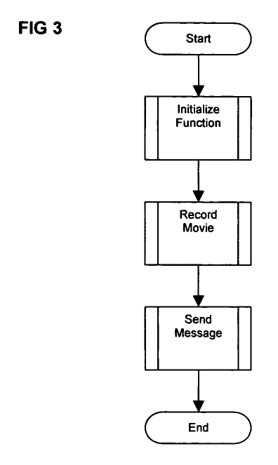

FIG. 3 illustrates the high-level steps for the method of one-touch messaging of arbitrary length that include initialization, record and send. Initialization prepares the method for recording and sending the movie message. In some implementations, segments of the initialization can occur periodically at a system defined frequency independent of a user initiated record and send. This eliminates the need for an incremental step to prepare the method for one-touch messaging. Recording encodes video and audio from the camera and audio interface into a virtual memory location that resides on the device's home network or a network location residing on the Internet. Sending transmits the message to a recipient as either a fully contained message with the movie attached or a message with a URI embedded in the body of the message.

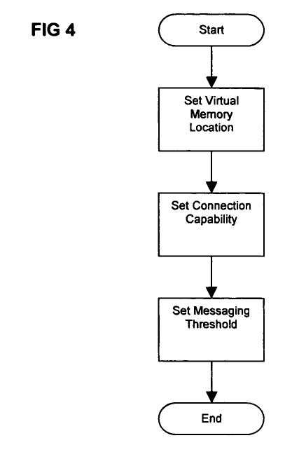

FIG. 4 illustrates the steps of initializing the method for one-touch messaging of arbitrary length. Initialization steps include setting virtual memory, testing the quality of the connection and setting the message size threshold. Given the storage required for capturing video, frames are moved into a virtual memory location that may be implemented as a very large working file capable of storing several minutes of MPEG video and audio. For example, a 1 gigabyte virtual memory file would be capable of storing approximately 200 minutes of MPEG video and audio recorded at 60 Kbps. The virtual memory location will be initialized at bootstrap for the device and point to a physical location on the device's home network or a network location residing on the Internet. In the case where the length of the movie message exceeds the storage capability of the virtual memory, secondary virtual memory files will be chained to store the remaining portions of the movie message. Initialization includes stablishing a working virtual memory location that is either local to the device or attached via a wireless or wireline network connection. The virtual memory is typically implemented with a large file on a permanent store that is opened one time. The file is only constrained by the size of the disk and any operating system or file system limitations that may exist.

The initialization method also determines the type and quality of the networking connection used to transport the movie message. The network connection will typically be fixed and determined based on the device's capabilities. This is not always the case if the device is connected to a communications device such as a DSL or cable modem. In this case, the device may connect to the modem via a high-bandwidth connection such as 10 Mbps but then bottleneck to the constraints of the external network connection. Depending on the quality of the connection, the bandwidth will vary. In one implementation, testing bits will be used to determine the quality at the time of send. The quality will be rated in terms of bits per second. In another implementation, the device may continually poll the quality of the connection. With continual polling, the function can utilize network quality data collected over a period of time to establish connection quality. Depending on the bit rate set, the method will establish a message size threshold expressed in units of bits or bytes. The message size will equal the bandwidth rating multiplied by time (R*T) where R is the bandwidth rating in bytes per second and T is the maximum number of seconds for experience latency. For example, if the maximum experience latency set by the device is 1 second and the rating of the connection is 10 megabits. Then, the connection is capable of 10 megabits and, thus, the message threshold is 10 megabits or 1 megabyte.

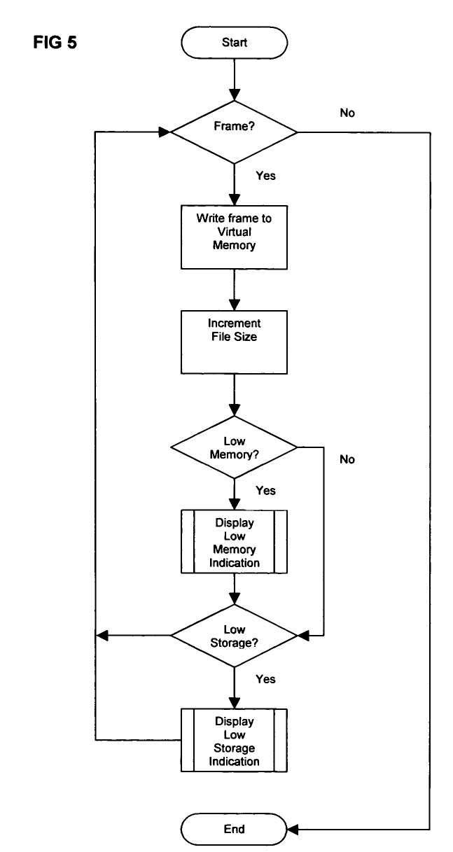

FIG. 5 illustrates a procedure for recording a movie message with audio and video. This one-touch procedure is invoked from a hard or soft button while viewing an address-book entry, from a menu for initiating the recording and sending of a movie message or from a voice or video call screen to record and send a movie message simultaneously with the call. Once recording is initiated by the end-user and as frames are placed into memory, a process will read and write each frame from the image capturing component to the virtual memory location. As frames are written to the virtual memory location, the method will track usage of virtual memory and available storage to save the file once recording is complete. With low memory and low storage conditions, the method will prompt the user with the condition. A preferred implementation is to overlay the video image on the LCD with a notice of the condition. Low thresholds should default to a percentage such as 50% of the required memory and storage. The parameter should be configurable. Prompt variations could occur as recording continues to utilize remaining storage.

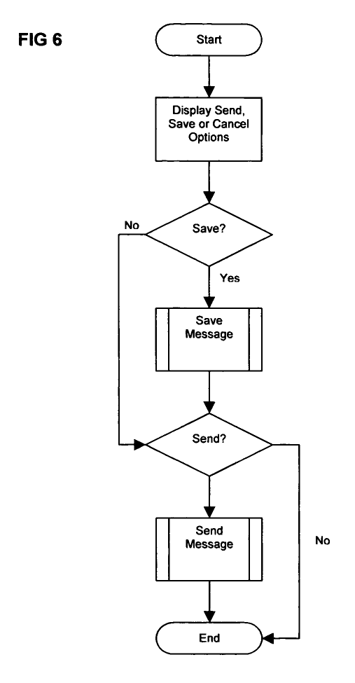

FIG. 6 illustrates a procedure for presenting the end-user with options for the most recently recorded movie message. In this embodiment, options include send, cancel or save. The cancel option will exit the method and clear memory for a subsequent recording of a movie message. The Send option will auto-compose the message based on parameters submitted to the method from the point of initiation. In an alternative implementation, the method may prompt the user for the to: address that will typically be a phone number or e-mail address, subject text and body text. Once composition is complete, the method will attach the complete video and audio message or insert a URI that refers to the originating network location source for the video and audio stream, assemble and send a message using an interoperable protocol such as the IETF e-mail protocols of the receiving server, and prompt the user to save or simply exit the message. Once the transmission is complete, the Send option will prompt the user to save the message and display the next prompt. Cancel will clear virtual memory, exit the function and present the next prompt.

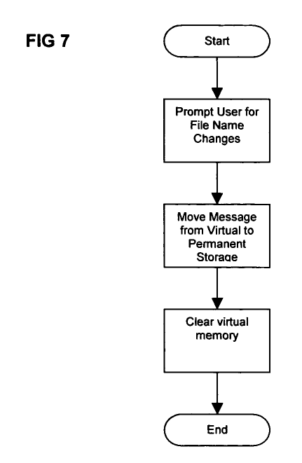

FIG. 7 illustrates a procedure for saving a movie message from virtual memory to permanent storage. Save will prompt the user for file name changes from a default name such as FILEXXXX, move the file from virtual memory to permanent storage and clear virtual memory. The save function should not introduce any end-user experience latency. In some embodiments, Save may not move actual data but instead may establish metadata to specify the virtual memory as permanent storage or initiate a background process that moves data independent of the user experience.

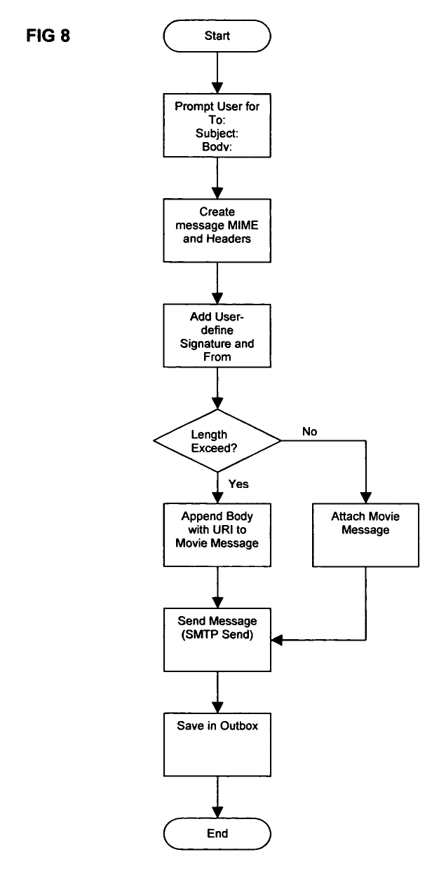

FIG. 8 illustrates the compose and send function. Once the movie message is recorded, the method invokes the process to compose and the send the message. The compose will automatically construct the message To:, CC:, Subject: and Body:. An alternative implementation will allow an end-user to specify these fields or override the method's defaults. The steps will then attach the full audio and video or a URI pointing to the audio and video residing on the originating network depending on the network threshold. When completed, the process will transport the message using a standard Internet message transport protocol such as SMTP. After the transport, the process will then conditionally store the sent message into a sent folder location that resides on the device or on a defined network location. If there are transmission problems, the method will place the message into an outbox folder for further processing when the network connection is available.

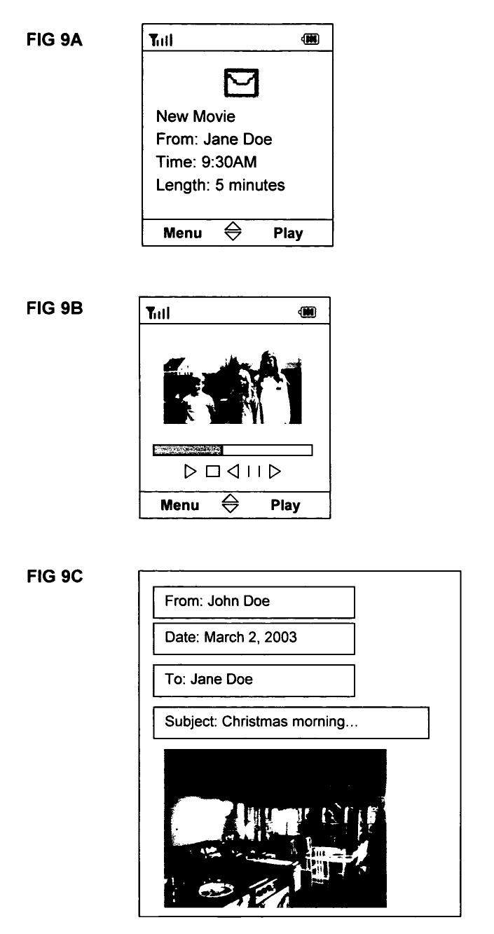

FIG. 9 is an illustration of a recipient receiving the one-touch arbitrary length movie message with video and audio. FIG. 9A shows a notification of a new message. FIG. 9B shows a view of the Movie once the user selects play from a new message notification. FIG. 9C shows an e-mail message containing the Movie. This illustration is of an image that is automatically played inline with the e-mail reader.

1. A method of sending arbitrary length video and audio content from an originating device such as a video camera or mobile phone to a terminating device such as a PC or mobile phone wherein the content is sent as a message with a video attachment encoded with a codec such as MPEG or uniform resource identifier (URI) that points to a storage location on a network that stores the recorded video and audio depending on the size of the message and the capabilities of the communications network used to transmit the video message.

2. The method of sending arbitrary length video and audio content of claim 1, wherein the content is recorded, processed, and sent following a one-touch button press in the context of an address book entry, active audio or video call, or other menu without further user input.

3. The method as claimed in claim 2, further comprising the step of automatically addressing recipients based on attributes in the address-book or menu or using a network identifier such as an IP address or phone number of recipients in an active call and populating other message fields such as the body and subject with pre-configured settings.

4. The method of sending arbitrary length video and audio content of claim 1, wherein the conditions for transmitting a message with a video and audio attached or a URI pointing to a network location storing the video and audio message are dynamically set depending on capabilities and quality of the network between the device and the server at the time of send.

5. The method as claimed in claim 4, further comprising the step of periodically testing the network connection at a pre-defined frequency to maintain a memory accessible quality metric that is used to compute the kilobyte threshold such that a networking quality test that may introduce user experience latency is not required at the time of send.

6. The method as claimed in claim 4, wherein the conditions of the network connection are utilized to set a kilobyte threshold where the message is sent with a video and audio attachment if the size of the video attachment is less than the kilobyte threshold, or the message is sent with an embedded URI if the size of the video is movie is greater than the kilobyte threshold.

7. The method of sending arbitrary length video content of claim 1, wherein the URI transmitted in the message is actionable by the recipient by double clicking the URI to initiate a streaming session using the file located on the storage network.
